(19) United States
(12) Patent Application Publication
(10) Pub. No.: US 2008/0172781 A1
(43) Pub. Date: Jul. 24, 2008

(54) SYSTEM AND METHOD FOR OBTAINING AND USING ADVERTISING INFORMATION

(76) Inventors: Terrance Popowich, Toronto (CA); Ian Hessel, Toronto (CA); Walter Wolanczyk, Barrie (CA)

Correspondence Address: TORYS LLP, 79 WELLINGTON ST. WEST, SUITE 3000, TORONTO, ON, M5K 1N2, omitted

(21) Appl. No.: 11/956,808

(22) Filed: Dec. 14, 2007

Related U.S. Application Data
(60) Provisional application No. 60/870,258, filed on Dec. 15, 2006.
(60) Provisional application No. 60/871,507, filed on Dec. 22, 2006.
(60) Provisional application No. 60/911,236, filed on Apr. 11, 2007.
(60) Provisional application No. 60/938,013, filed on May 15, 2007.

(51) Int. Cl. G06Q 30/00; A47K 11/04; G09F 23/00; G06Q 90/00

(52) U.S. Cl. 4/476; 705/14

(57) ABSTRACT

Method for estimating the number of persons is described. The methods can be used in conjunction with advertising and to monitor performance of the advertising in reaching an audience. The methods can also be used in conjunction with a maintenance system to schedule maintenance activities based on volume of use. Systems, apparatus, computer signals and computer programming relating to and implementing the methods are also described.

This application claims the benefit of U.S. Provisional Application Nos. 60/870,258 filed 15 Dec. 2006; 60/871,507 filed 22 Dec. 2006; 60/911,236 filed 11 Apr. 2007; 60/938,013 filed 15 May 2007, which applications are hereby incorporated by reference, including all appendices and other documents attached thereto.

### BACKGROUND OF THE INVENTION

The invention relates to systems and methods for estimating a number and/or other characteristics of persons or things, and particularly to systems and methods useful for estimating numbers and other characteristics of persons and other things included in visual representations and/or images of such persons, things and the like.

The invention further relates to systems and methods for obtaining and utilizing information relating to persons or things, and particularly to systems and methods useful for advertising and/or use of fixed, portable, mobile, re-locatable or temporary structures, such as portable toilets, trailers, billboards, mobile billboards, waste bins, and the like.

### SUMMARY OF THE INVENTION

In various aspects the invention provides apparatus, systems, methods and computer programming for estimating a number of persons or things, and/or for gathering and otherwise processing statistical data relating to fixed or portable advertising. The data may be used to evaluate the effectiveness of advertising structures, materials and campaigns, and additionally or alternatively, to schedule maintenance or upgrade work associated with such advertising.

In various embodiments the data can be gathered by motion and/or proximity sensors are placed at or near advertising structures or materials to track persons coming into viewable or other effective proximity of advertisements. Such sensors may be used to track foot or other audience traffic near an advertisement. The tracking data may be stored locally to be accessed at a later time, and/or it may be sent in real time over a wired or wireless network to be collected and analyzed at a remote location. The data can be used to analyze the traffic that is exposed to particular locations, advertisements, or both, and to access, control, or otherwise effect contractual or business relations related to, for example, the display of advertisements and the sale of advertising space. In an embodiment, the tracked data can also be used to schedule and control maintenance and other procedures for portable structures.

In alternative embodiments, the data can result from one or more estimations. For example, in an aspect of the invention, there is a method of estimating the number of persons or things. The method includes: receiving data representing a visual image of the persons or things; analyzing the data in the frequency domain to observe one or more edge properties of one or more edges of an outline of the persons or things in the visual image; and estimating presence of persons or things represented by the data by comparing the one or more edge properties against a model set of characteristics for the persons or things. A person or thing is counted in the number of persons or things for each set of the one or more edge properties that correlate to the model set of characteristics.

The analyzing the data may include separating one or more areas of the visual image showing the persons or things from one or more background areas, and analyzing the one or more areas showing the persons or things to observe the one or more edge properties of the persons or things.

The model set of characteristics may be predetermined. The model set of characteristics may be updated. The model set of characteristics may be updated by self-training. The one or more background areas may be determined by comparison to a background model set of characteristics. The background model may be updatable. The one or more edge properties may be determined to correlate to the model set of characteristics by meeting a threshold number of characteristics in the model set of characteristics.

The number of persons or things may be counted for persons proximal to an advertising. The advertising may be attached to a portable structure. The portable structure may be a portable restroom.

In another aspect of the present invention, there is a portable restroom system. The system comprises: a portable structure having a toilet therein; a sensor in the portable structure for detecting persons entering the portable structure; and an advertisement inside the portable structure. The persons entering the portable structure is exposed to the advertisement, and a count of the persons entering the portable structure is provided by the sensor.

The count of the persons may be transmitted to a processor. The processor may be remote from the portable structure, the processor may be tabulating the count of persons over different time periods for the portable structure. The processor may generate a message upon detecting the count of the persons has reached a threshold, and the message may be sent to a receiving device to initiate an activity for the system. The activity may be cleaning of the portable structure. The activity may be deploying another portable structure proximal to the portable structure.

The processor receives another count information relating to another number of persons entering another portable structure, the another portable structure may have another advertising associated with the another portable structure, the another portable structure may have another sensor associated with the another portable structure, and the processor may tabulates the count of persons and the another count information to provide a report. The report may include a total count of persons exposed to the advertising in the portable restroom system.

In another aspect of the invention, there is a system for tracking a performance of an advertisement. The system comprises a sensor for estimating a number of persons proximal to the advertisement and a processor receiving from the sensor the number of persons. The processor tabulates the performance of the advertisement as a function of the number of persons over one or more time periods. The tabulating the performance provides a report on the advertisement, the report being used analyzed for a decision regarding the advertisement.

The sensor and the advertisement may be attached to a portable structure. The advertisement may be inside the portable structure, and the sensor may be adapted to estimate the number of persons proximal to the advertisement inside the portable structure. The portable structure may be a portable restroom. The sensor may be an infrared sensor. The sensor may be a thermal sensor.

The advertisement may be attached to an exterior of the portable structure, and the portable structure may be a portable restroom.

The decision may include updating the advertisement, upon the report indicating that the performance of the advertisement is above a threshold. The decision may include deploying another portable structure with the advertisement attached thereon proximal to the portable structure. The decision may be to replace the advertisement, upon the report indicating that the performance of the advertisement is below a threshold.

In yet another aspect, there is a method for tracking a performance of an advertising campaign. The method comprises: estimating a number of persons proximal to each of one or more advertisements placed throughout a venue; receiving the estimated number for each of the advertisements; determining the performance of the advertising campaign as a function of the number of persons over one or more time periods for each of the one or more advertisements; evaluating the performance of the advertising campaign, and making a decision regarding the advertising campaign as a function of the performance of the advertising campaign.

At least one of the one or more advertisements may be attached to a portable structure. The at least one of the one or more advertisements may be inside the portable structure, and the estimating of the number of persons proximal to the at least one of the one or more advertisements may be performed by a sensor adapted to estimate the number of persons proximal to the at least one of the one or more advertisements inside the portable structure. The portable structure may be a portable restroom. The sensor may be an infrared sensor. The sensor may be a thermal sensor.

The at least one of the one or more advertisements may be attached to an exterior of the portable structure, and the portable structure may be a portable restroom.

The decision may include updating the advertisement if the performance of the advertising campaign is above a threshold. The evaluating the performance of the advertising campaign may include determining a location at the venue at which the number of persons proximal to one of the one or more advertisements is relatively higher, and the decision regarding the advertising campaign may include deploying at least one of an additional advertisement or an additional portable structure at the location. The evaluating the performance of the advertising campaign may include determining a location at the venue at which the number of persons proximal to one of the one or more advertisements is relatively lower, and the decision regarding the advertising campaign may include removing at least one of the one or more advertisements from the location.

In other aspects, apparatus, systems, methods, computer signals and computer programming relating to aspects of the invention are provided.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes):

FIG. 1 is block diagram of an advertisement information system;

FIG. 2 is flow chart block diagram of an exemplary method of estimating a number of persons or things usable alone or in conjunction with the advertising system of FIG. 1;

FIG. 3 provides transition charts relating to data analysis techniques useful in implementing embodiments of the method of FIG. 2;

FIG. 4 is a flow chart block diagram of an exemplary method of estimating a number of persons or things in accordance with the invention, incorporating of FIG. 2;

FIG. 5 is a graph showing a density and probability curve in an exemplary implementation of the method of FIG. 2;

FIGS. 6 and 7 are schematic block diagrams of exemplary processes useful in implementing embodiments of the invention;

FIGS. 8 and 9 are schematic block diagrams of exemplary processes useful in implementing alternate embodiments of the invention;

FIG. 10a is a block diagram of an alternate advertisement information system;

FIG. 10b is a cross-sectional view of a portable structure in the system of FIG. 2a;

FIG. 10c is a perspective view of a casing and sensor of the structure of FIG. 2b;

FIG. 11 is a block diagram of a network of devices in an alternate advertisement information system;

FIG. 12a-d are exemplary displays relating to a data analyzer in an advertisement information system;

FIG. 13 is an exemplary display of analytical information relating to the data analyzer of FIGS. 12a-d;

FIG. 14 is an exemplary display of a further alternate advertisement information system; and

FIG. 15a-c are exemplary displays relating to the data analyzer of FIGS. 4a-d.

FIG. 16 is a block diagram of a further embodiment of the invention; and

FIG. 17 is a block diagram of a still further embodiment of the invention.

### DETAILED DESCRIPTION OF THE PREFERRED EMBODIMENTS

The description which follows, and the embodiments described therein, are provided by way of illustration of an example, or examples, of particular embodiments of the principles of the present invention. These examples are provided for the purposes of explanation, and not limitation, of those principles and of the invention.

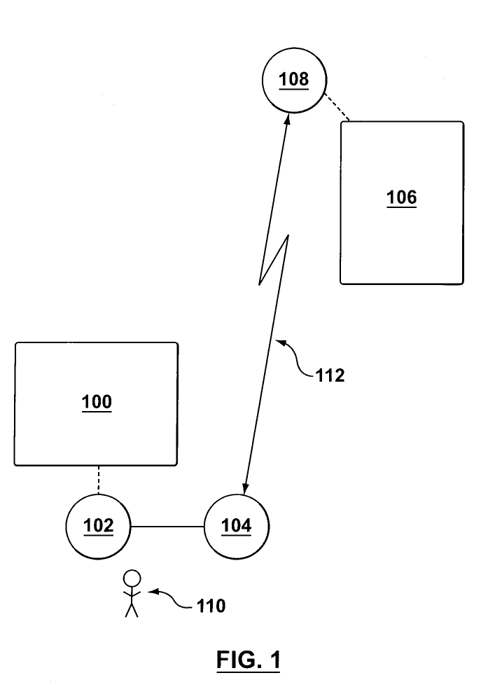

FIG. 1 is a block diagram of an exemplary system for obtaining and using information relating to advertising. Therein, advertisement 100 is made available to an audience 110. Audience 110 can comprise one or more persons able to view, hear, or otherwise be exposed to advertisement 100. Advertisement 100 may be of different types, including a traditional billboard type passive advertisement with visual elements, an active display that can be changed quickly (such as mechanical board slats or television displays), and other multi-media presentations, which can also be interactive.

Advertisement 100 may be stationary (such as a billboard), mobile (such as attached to a moving vehicle), or portable (such as attached to a portable structure, for example, portable toilet structures). Advertisement 100 may be static or dynamic. For example, advertisement 100 can include paper or other printed media, and/or may include displays for showing multiple images or multimedia content. Such displays can for example include televisions, or projection, LCD, LED or plasma displays. The displays can also include mechanical apparatuses for changing advertising images.

In the embodiment shown in FIG. 1, advertisement 100 is associated with systems and methods for detecting, or estimating, the presence and/or characteristics of an audience 110 and/or objects proximal to advertising 100.

In some embodiments, this can be accomplished by way of one or more sensors 102. Depending on the nature of advertisement 100, sensor 102 may be placed with or near advertisement 100, or at or near a point at which an audience is expected to gather. For example, a larger billboard mounted at an elevation may have a sensor 102 placed at ground level away from the billboard to detect pedestrian traffic near the billboard, and also potentially have more sensors 102 placed farther away at distances in which the billboard can be reasonably viewed. In other embodiments, such as smaller advertisement 100 that is placed in or on a portable structure, sensor 102 may be much more proximal, or in fact mounted with, the portable structure or advertisement 100 itself. It will be appreciated that in other embodiments, there are other ways to associate a sensor 102 with particular advertisements 100 in order to observe exposure of an audience 110 to the particular advertisement 100. In alternative embodiments, still or streaming video images captured by a camera can be used to estimate the size of audience 110 or number of things. Sensor(s) 102 may be integrated with, or connected to, communication device(s) 104 for transmitting audience 110 tracking data observed by sensor 102. In the embodiment shown, this data is transmitted wirelessly (represented at 112 in FIG. 1) to another communication device 104 connected or integrated with data analyzer 106. It will be appreciated that other transmission means, such as wired communications, is possible in other embodiments.

For such embodiments, data analyzer(s) 106 include data repository(ies) for storing data received from one or more sensors 102 at one or more locations having advertisements. As described in more detail below, data analyzer 106 include technologies to analyze tracking data received from sensors 102, generate reports and statistics relating thereto, and provide control over the deployment of advertisements 100 and services relating thereto in different embodiments.

It will be appreciated that in other embodiments, transmitters 104 may be avoided, or augmented, by having data storage (not shown) connected to sensor 102, so that audience 110 tracking data can be stored and periodically retrieved for insertion into, and analysis by, data analyzer 106.

Sensor 102 may include, for example, motion detectors, thermal devices, pressure sensors, optical or video cameras, and other devices for detecting and/or estimating the presence, size, location, physical orientation, and duration of viewing, of an audience 110. Such sensors 102 can also be calibrated to detect for other persons or things as defined by certain characteristics.

For example, in an embodiment, a sensor 102 used with advertisement 100 associated with the interior of a confined space may be an infrared (IR) pulse sensor. For tracking audience 110 inside the space, the IR sensor can provide a reflectable beam that, when interrupted by a person entering the space, allows the sensor to detect the presence of the person. Such sensors can be mounted overhead or side-mounted in a structure associated with the space. For sensing audience 110 of advertisement 100 that is not within a structure, an IR sensor can similarly be used to track the presence of audience 110 when an IR beam is broken. The use of motion- or direction-sensitive devices such as, for example, two or more trip beams devices can be used to gather data on traffic patterns. For example, the use of multiple laser or other trip beams and determination of the order in which beams are broken by a moving audience member can allow a monitor of the beams to determine the direction in which a person or other member of audience 110 is traveling. IR pulse sensors suitable for use with such an implementation include models available from TrafSys and SenSource, such as model numbers PCW-DB2-S, PCW-DB2-F and PCW-SSRX4.

It will be appreciated that IR sensors are generally useful for areas in which for example the expected concurrent volume of people in audience 110 to be detected is relatively low, since a constant stream of people entering and leaving the detection area, especially in groups, will yield constant breakage of the IR beams and hence provide an in some circumstances less accurate counting. Thus, IR sensors may be preferred for inside a confined space, such as a portable structure, where at any one time audience 110 is expected to be only one or two people.

For areas where larger crowds are expected, it may be preferred to employ sensors 102 that use thermal imaging or other detection methods to detect traffic through areas to which advertisement 100 is exposed. In some embodiments, for example, one or more thermal imaging sensors 102 can provide sampling snapshots of audience 110 within in the view of the thermal camera(s) of sensor(s) 102. Software filters can be used to analyze the thermal images provided by such sensors at specified time intervals and detect changes in the volume of audience members from interval to interval. Such techniques and algorithms can then provide tracking data as to the volume of people of audience 110 in a detection area over any recorded period of time. For example, an estimation technique based on a visual image/streaming video can be used, as described in detail below.

In other embodiments, digital video cameras or other sensors can be used as sensors 102. In still other embodiments, sensors 102 and/or device(s) 104 can include circuitry to track RFID transponders or other wireless devices embedded in badges or fobs or otherwise carried by audience members that enter and leave an advertisement-exposure area. Exemplary wireless devices can include, for example, cellular phones or other wireless enabled personal digital assistant (PDA) carried by a person in audience 110. As devices enter and leave tracked areas, the proximity and exposure of the devices, and therefore the audience members by whom they are carried, to advertising can be tracked, such as sensor 102 and/or device 104. In such embodiments, information and promotional materials can also be wirelessly transmitted to such wireless devices as they are in the tracked area through one or more wireless protocols, including bluetooth. Such communication can be effected by sensor 102 or communication device 104.

It will be appreciated that for any particular embodiment, one or more sensors of one or more types can be used, alone or in various combinations, as appropriate for the application, the advertisement 100 being displayed, and the targeted or observed audience 110.

Image interpretation software and/or devices can also be used in conjunction with sensors 102, in order for example to provide further details on the physical attitude and/or reactions of viewers of advertising displays, as described in greater detail below.

Data analyzer(s) 106 can be configured with communication device(s) 108 to receive audience 110 tracking data from one or more sensors 102 and, for example, where desired, to push back advertisement, confirmational, or other information to member(s) of audience 110. In various embodiments, communication device(s) 108 can include wireless data controllers, such as one or more Point Six Wireless Point Managers, or TrafSys models MIU-1000 or MIU 1500, connected to computer(s) housing data analyzer 106. Data analyzer(s) 106 can store tracking data received from device(s) 104 associated with one or more advertisements 100 using one or more storage devices local or remote to the computer, and utilize the resources of the computer to effect calculations and analysis on such data.

As described above, a sensor 102 may be a camera providing still and/or streaming video information that is then used to estimate a number and characteristics of persons or things. Thus, such sensors 102 can include apparatus, systems and methods that are useful to determine numbers and other characteristics of persons and/or other things present within or otherwise appearing in a given area or image, such as for example within a live or stored visual representation, such as still or moving images, or within a field of view. Such apparatus, systems and methods are particularly useful, for example, for implementation in computer-controlled applications for estimating the numbers and reactions of persons in a crowd being monitored, such as by surveillance camera or cameras at an event, or for providing active presentations in which the presentation is actively adjusted based on detected and/or estimated characteristics of the person(s) in the audience. As already described above in some embodiments, such techniques can be useful, for instance, for estimating the number and other characteristics of spectators at an event, numbers and other characteristics of persons at designated locations (at an event or otherwise), or the numbers or other characteristics of persons that are in the vicinity of certain buildings, landmarks, attractions, or advertising media. In addition to estimating numbers and other characteristics of persons in such circumstances, the estimation of numbers and other characteristics of other things can also be desired. Further details regarding the estimation of such numbers and characteristics, and other embodiments applying such techniques, are now provided.

The estimation of the number and other characteristics of objects (be it either persons or things) within a visual representation can tend to be difficult, particularly where such persons or objects are present in high density, due to different factors including occlusion of objects by each other; varied motion or the lack thereof; unknown intrinsic camera parameters for obtaining the visual representation; unknown camera position relative to the scene of the visual representation; and/or unpredictable lighting changes.

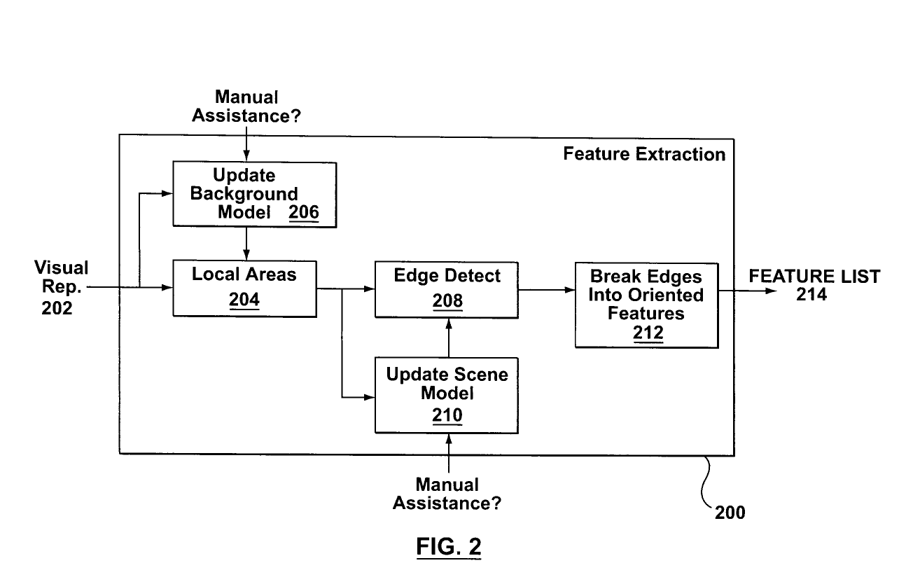

FIG. 2 is a flow chart block diagram of an exemplary method for use in estimating numbers or other characteristics of objects in accordance with the invention. As shown, feature extraction process 200 of FIG. 2 comprises providing data corresponding to a visual representation 202 to a computing system or other data processor for processing. At 204, visual representation data 202 is compared to data representing a background model, which permits the analysis of data representing “foreground” areas that may represent objects of interest, such as people. Such areas of interest are sometimes referred to herein as “blobs”. As visual representation 202 is processed, the background model can be updated as appropriate, at 206, such as to adjust for daylight to nighttime changes and/or to stationary objects placed into the scene and which become part of the background. In some applications, the extraction of foreground data for further number analysis can be limited to one or more particular areas of the visual representation that are of interest, for example, such as may be desirable if one is trying to determine the number of persons in line at a concession stand or the number of persons within a certain distance from an advertisement.

As will be appreciated by those skilled in the relevant arts, “background” models useful in processes according to the invention are models of any information likely to be present in a representation of an image that is not of interest. Such models can represent, for example, static items located within a field of view, regardless of their relative position within the field of view, or predicted or expected items, such as items which appear on a recurrent or predictable basis and are not of interest to the analyst.

A background model can be defined using a number of characteristics of a background scene. For instance, for a scene at an event in which a number of persons present within a given area is to be estimated, a background model can derived using a statistical model of the scene as it appears prior to entry of people to be counted. For example, one manner of analyzing a background model is to record data representing the background scene on a pixel-by-pixel basis.

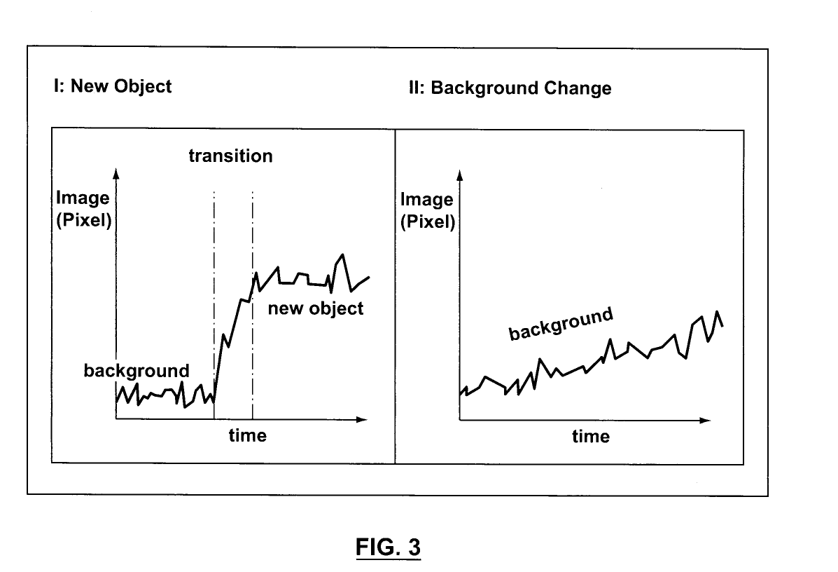

Referring to FIG. 3 one concept of an exemplary method of updating a model of a stationary background, as shown at 206 in FIG. 2, is shown. The entry of a new object into the visual field can be determined as a sharp change in the image characteristics over time. For example, changes within pixels representing the entirety or a sampling of an image can compared be observed over time, such that a sharp transition (shown as L: New Object) can be interpreted as entry into the scene of a new object, whereas a gradual change in the pixel (image) quality or characteristics can be interpreted to be merely a change in the background, such as due to changing lighting conditions. Should a new object be determined to have entered the scene, and if the new object remains in the scene for long enough, the background model can be updated to reflect that the background scene should include the new object.

Conversely, a short-term or other previously-undetected presence of a new object can be interpreted as entry of a persons or other thing of interest to the scene. Thus, a person skilled in the relevant arts would appreciate that the processes of locating of areas of interest and updating of background models can inform one another. Furthermore, as shown in FIG. 1, the process of updating the background model can also include manual intervention by an operator of the computing system for estimating the number of objects, especially for difficult cases that the system has lower confidence in determining background change or area location. For example, the system can flag particular change scenarios for operator intervention, either real time or as stored scenarios for later analysis.

Thus, in an exemplary embodiment background model 206 can include a set of statistical measures of the behavior of the pixels that collectively represent the appearance of the scene from a given camera in the form of an image, such as a video frame image. The background model is for measuring static areas of the image, such that when a new dynamic object enters the field of view of the camera, a difference can be detected between its visual appearance and the appearance of the scene behind it. For example, if a pixel is thought of as a random variable with modelable statistical traits, pixels depicting portions of a new object on the scene would be detected as having significantly changed statistical traits.

The identification of areas of interest within an image can be accomplished through visual comparison of a background model against another visual representation. Alternatively or additionally, foreground models can be constructed to detect foregrounds (i.e., areas of interest). This could for example be accomplished using orthogonal models to detect areas that appear to include objects for which a number or other characteristic is to be determined, which models set out generic features of the object. Another foreground detection method that can be used is motion detection, in which frame subject methods are used to determine foregrounds, in the object is a mobile one (such as persons or vehicles).

Referring back to FIG. 2, a person of skill will appreciate that, optionally, background separation and the identification of areas of interest 204 can be skipped, and the visual representation can be passed directly to edge detection 208 without first removing or otherwise accounting for the background. While this may tend to be more computationally intensive, it can tend to reduce or eliminate the need to create and update a background model. For example, one way of proceeding can include using foreground modeling and/or segmentation processing to find any areas of interest. Regardless of whether areas of interest are identified, the process then can move to edge detection processing 208 of the area(s) of interest, or the entire visual representation 202, as the case may be. The following description refers to “blobs” or “areas of interest”, but it is equally applicable to an implementation in which the entire visual representation 202 is analyzed.

In edge detection processing 208, the system analyses the areas of interest to observe one or more frequency properties to the edges of the outline(s) of each area of interest. For example, a frequency transform applied an exemplary two dimensional (such as an x, y pixel pair) signal of the visual presentation 202 can be taken to determine edge properties of the area(s) of interest. A frequency decomposition algorithm known in the art, such as Fourier transform, discrete cosine transform and/or wavelets, can be used to reorganize image information in terms of frequency instead of space, which can be considered a visual image's innate form. Several frequency decomposition algorithms can be used to perform a subset of the normal decompositions, focusing only upon a range of frequencies. In general, these algorithms are termed “edge detection algorithms”. In an exemplary implementation, the Sobel Edge Detection algorithm can be employed with standard settings for both horizontally and vertically oriented frequencies to obtain edge property information.

Edge detection processing 208 can also be informed by a scene model 210, which like the background model can be updatable to describe a geometric relationship between a visual source (e.g. a camera) and a three dimensional scene being observed by the visual source. Scene model 210 can, but need not, also describe a camera's parameters such as lens focal length, field of view, or other properties. Scene model 210 can be used with edge detection 208 to help inform processing 208 in its detection of edge properties to any identified areas of interest.

Once edge detection 208 is complete, the process moves onto breaking each edge and its associated edge properties 212, into oriented feature(s). An oriented feature is for example an edge property that relates to the orientation of an edge on the visual representation, such as vertical, horizontal, or diagonal, including at various degrees and angles. Generation of edge properties, such as oriented features, can be tabulated or tracked as a feature list 214.

Feature list 214 can for example include a plot or a histogram of information for any edge property, or feature, that is broken out at 212. To estimate the number of objects in the visual representation, feature list 214 can be compared against a model set of characteristics for the object whose number is being estimated. For instance, if the number of persons is being estimated, there can be edge characteristics to persons that are set out in the model, which can be compared to feature list 214 to estimate the number of persons in visual representation 202. In one implementation, it has been found that a human model with eight defined edge characteristics can provide a fairly reliable indication of person(s) in a visual representation. In the exemplary implementation, the eight edge features are derived from their orientations, and can be computed as follows. The image is convolved with a horizontal and vertical Sobel filter using standard settings, resulting in two corresponding horizontal and vertical images, in which the intensity of the pixel value at any given location implies a strength of an edge. The total strength of the edge at any particular point in the image can therefore be defined as a vector magnitude as calculated from the horizontal and vertical edge images. In this example, if this magnitude is greater than half the maximum magnitude across the entire image being considered, then it is considered a feature. The particular feature can be measured for its orientation by calculating the vector angle. For example, a 360 degree range can be broken up into eight equal parts each representing 45 degrees, the first of which can be defined to start at −22.5 degrees. A histogram of these eight features can then be assembled based upon the number of incidences of each feature with a given region. It will be appreciated that this example given above is a simplification of an approach that can incorporate the use of more than a slice of image frequencies coupled with spatial constraints that can further model the outline of object(s) in an area of interest.

Thus, in an embodiment the estimation of a number of objects can be handled by the computing system by matching a histogram of feature list 214 against an object model and looking for the number of matches. In the example of a person, one or more edge characteristics can be defined for each body part (such as the head and/or arms),which can be matched against feature list 214 generated from visual representation 202. From the number of resulting matches, an estimate can be made, within desired or otherwise-specified error margins as dictated in part by the level of detail in the object model, of the number of persons (i.e. objects) in visual representation 202. In the embodiment, the system can be trained by providing multiple examples of humans at a distance and crowds varied in density and numbers, which can be hand labeled for location and rough outline. The training can be a fully automated process, such as with artificial intelligence, or partially or wholly be based on manual operator intervention. With this training information, a feature histogram can be generated for each person, where it is normalized for person size given by a scene model. Each of these “people models” can then be used to train a machine-learning algorithm such as an support vector machine, neural network, or other algorithm, resulting in a generalized model of human appearance (“GMHA”) in the feature space. Thus, a simple initial approach can be to accumulate individual feature histograms to create a collection of features of an entire group, which can then be normalized by a total number of people used for training to result in the GMHA. During live operation, new images and/or sub-parts thereof, can be feature-extracted, normalized and used to produce feature histogram(s). These new feature histogram(s) can then be compared to the GMHA, using a machine learning algorithm such as those described above. In a basic example, the number of incidences of GMHA features within the new feature histograms can denote the number of objects (i.e., persons or things) within a given visual representation, such as an image or a sub-image.

Thus, it will be appreciated that greater or fewer characteristics can be defined in an object model with respect to the object being estimated, which can provide for greater or lesser confidence in an estimation of the number of objects in a visual representation being analyzed. Since the model characteristics, and the threshold or criteria for declaring a match can all be set and adjusted as desired for a particular application, the estimation process can tend to be optimized towards particular applications. For example, for the estimation of numbers of persons in dense crowds, the system would tend to have a more detailed object model of a human head and/or shoulder, so that only a partial view of the head and/or shoulder would be sufficient to generate the edge property that would result in a match.

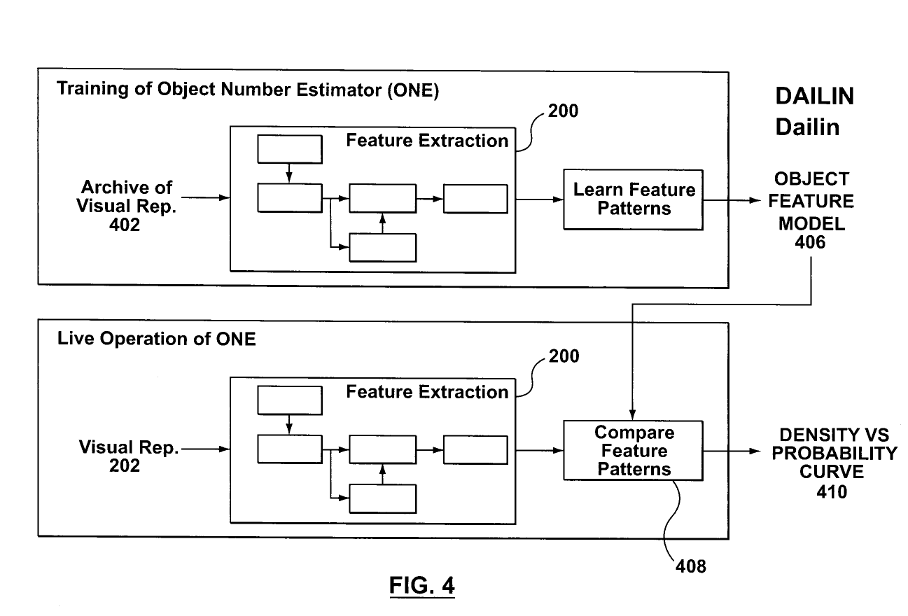

Referring for example to an implementation for counting persons in a crowd, as shown in FIG. 4, process 200 provides feature list 214 (not shown in FIG. 4) to comparator 408 for matching edge properties of the visual representation 202 against features of object model 406. Also shown in FIG. 4 is a training process that can optionally be used to update the object feature model 406. Therein, a video archive of crowds can be fed through feature extraction process 100 to generate an archive feature list that the system can learn at 404 as being characteristics of persons in a crowd, which can then be used to update or revise model 406 with edge properties as appropriate.

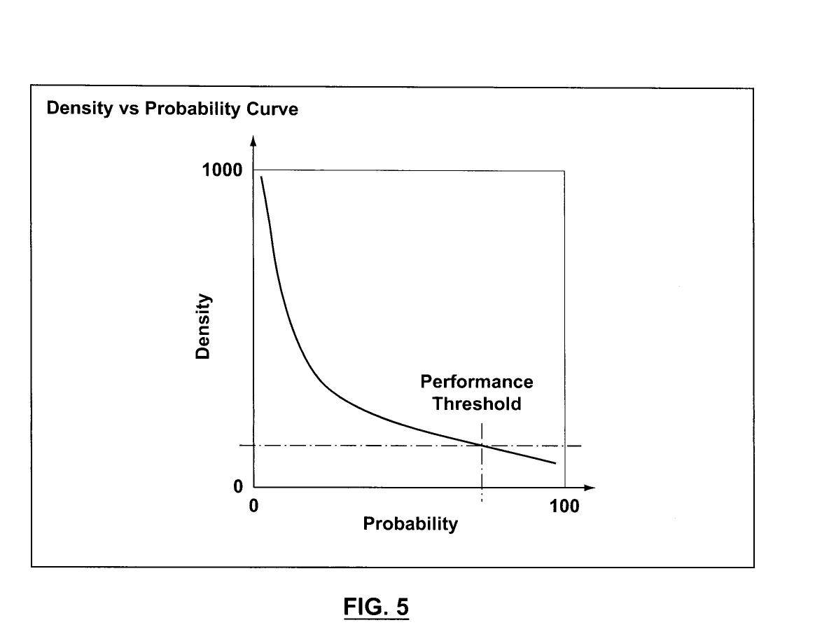

From a comparison of feature list 214 with object model 406 in block 408, a number (or density)/probability curve 410 can be constructed to track if a match has been made. An example of such a curve is shown in FIG. 5. Such a curve shows the number (or density) of persons at different probabilities, and permits a performance threshold to be set by a user of the system. For example, the curve of FIG. 5 permits reports to be generated to state that a certain number of persons are shown in the visual representation at a particular percentage probability.

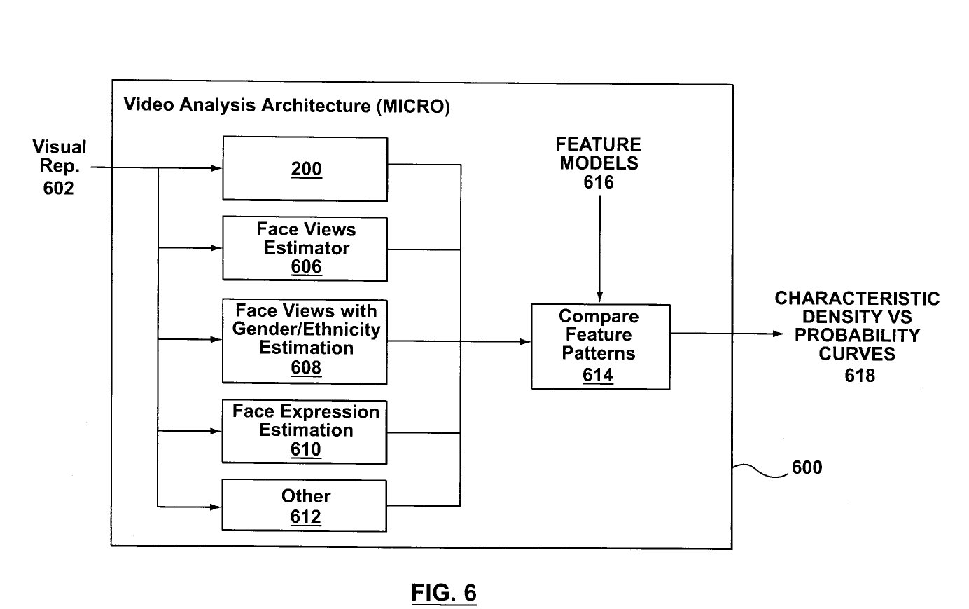

In alternate embodiments, additional or alternative characteristics of persons or other objects can be determined in addition to merely the number of objects. For example, if the system is used to estimate the number of persons, more parameters regarding the persons can be specified, such as number of persons of particular age/gender/ethnicity, number of persons with positive facial expressions, number of persons with negative facial expressions, or number of persons wearing cloths of a particular color or style. In particular, for implementations relating to advertising, it can be desirable to be able to estimate or otherwise determine the number of persons that react “positively” or “strongly” to the advertising by observing the number of persons with “positive” or “strong” facial expressions in the vicinity of the advertising. For example, in advertising media, one audience measurement metric is whether there is a strong reaction to advertising that can be correlated to memory retention by the audience. It will be appreciated that for other objects, different estimation parameters or characteristics may be specified. Referring to FIG. 6, there is shown an example of a video analysis architecture 600 for estimating the number and determining other characteristics of a group of persons within a video image. In architecture 600, visual representation 602 of the group of persons is analyzed by the feature extraction process 200, customized for persons as described above, in addition to one or more of face view estimator 606, gender/ethnicity estimation 608, expression estimation 610, or other analysis 612. Feature models 616 relating to each of these analysis processes can be then compared to with extracted features from each or any of 200, 606, 608, 610 and 612 at block 614, so as to determine a number matches for each feature to estimate the number of persons fitting parameters defined with the feature extraction in 606, 608, 610 and 612. Models 616 in this example could include model object features in model 406 described above, as well as other features relating to the estimation parameters defined with 606, 608, 610 and 612. A person of skill in the relevant arts will appreciate that these model characteristics and the comparison thereof to generate number (density)/probability curves 618 are similar to that described above with respect to curve 416, and so such details are not described again with respect to 606, 608, 610, 612 and 618.

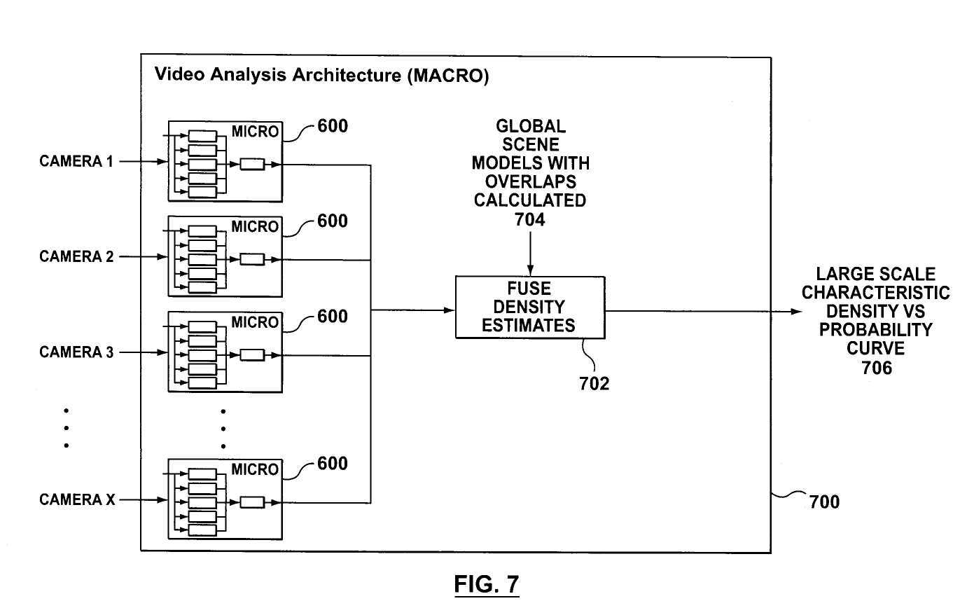

While the foregoing has been described with reference to a single source of visual information, the apparatus, systems and methods described herein can be applied to multiple sources of visual information so as to provide scalability over large areas. Alternatively, if two or more visual information sources are provided to the same physical location, the estimates resulting from each source can be correlated to provide greater confidence in the estimate of the number of the object in the location covered by the visual information sources. For example, building on the example described above with reference to FIG. 6, in FIG. 7 there is shown an architecture 700 (designated as “macro” as opposed to the “micro” designation of architecture 600 shown in FIG. 6) that utilizes multiple cameras to provide multiple visual representations of different locations of an event, in which a micro architecture 600 is associated with each camera in order to generate number estimations and number (density)/probability curves 706 for the event. In architecture 700, any overlaps in views captured by different cameras can be calculated and stored as global scene models 704, which can be used to ensure that the same objects, such as persons, are not counted more than once due to the object appearing within views of two or more cameras or visual sources. The total cumulative number (density)/probability estimates of an event can then be created as curves 706, representing estimates as seen by the entire camera or visual source network.

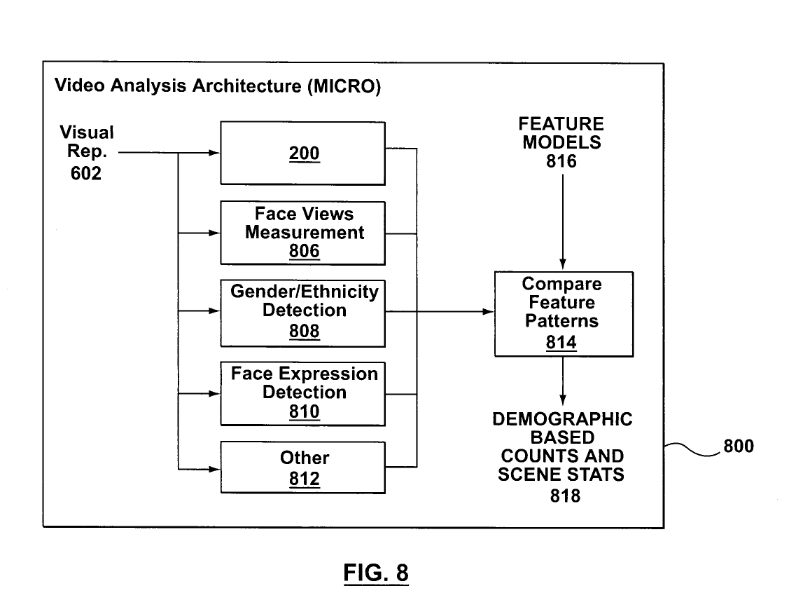

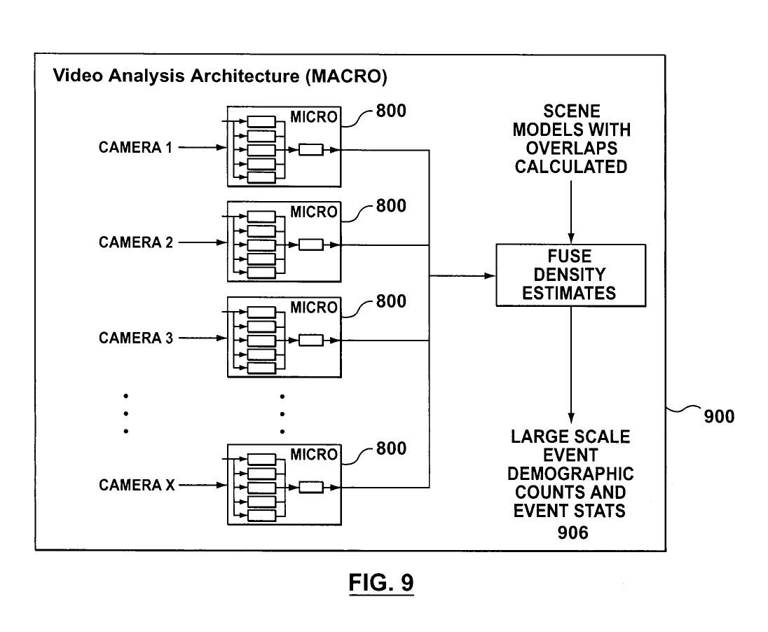

The output of the micro/macro architectures need not be number (density)/probability estimates or curves, but the system can be specified to output other types of information as well, including for example statistics and counts. Referring for example to FIGS. 8 and 9, micro architecture 800 and macro architecture 900 similar to architectures 600 and 700 respectively are shown. However, in place of outputting a number (density)/probability curve as in architecture 600, architecture 800 is set to estimate and output demographic-based counts and scene (such as, of visual representation 602) statistics. Thus, macro architecture 900 shown in FIG. 9 can be utilized to measure large scale event statistics similarly to architecture 700, but output results as event demographic counts and statistics 906.

As will be appreciated by those skilled in the relevant arts, any type of information derivable from data representing images may be used as output, particularly in advertising applications those types of data useful in assessing the effectiveness of displayed images, including for example, advertising images.

For a camera used in a system described herein, it can be calibrated in order to give greater confidence in number estimations. For example, a camera can be calibrated to generated geometric relationship(s) between a three-dimensional scene being observed by the camera. Such calibration can be automatic or manual, and can include use of template patterns, calibration periods and/or computer annotation of video frames. For instance, an automatic approach can leverage any prior or common knowledge about a size of readily detectable objects. As an example, persons can generally be readily detected through an approach involving of background segmentation as discussed above. If an algorithm is tuned to assume that objects of particular pixel masses are persons, the knowledge that people are generally roughly 170 cm tall can be used to calculate a rough relationship between the size of objects in an observed scene and their pixel representation(s). Thus, if the algorithm performs this task upon people standing in at least 3 locations in an image, the an estimate of the relationship between the camera's orientation relative to the physical scene can be calculated.

In various embodiments, systems and methods as described above for tracking, sensing, and/or estimating number and/characteristics of persons or things may be implemented in conjunction with advertisements. The advertisement may be fixed (such as billboard style), mobile, or placed on portable structure(s), such as portable toilet(s).

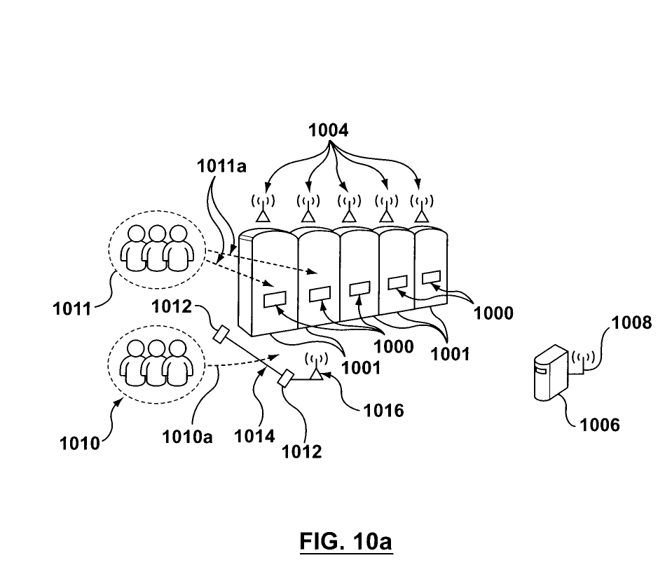

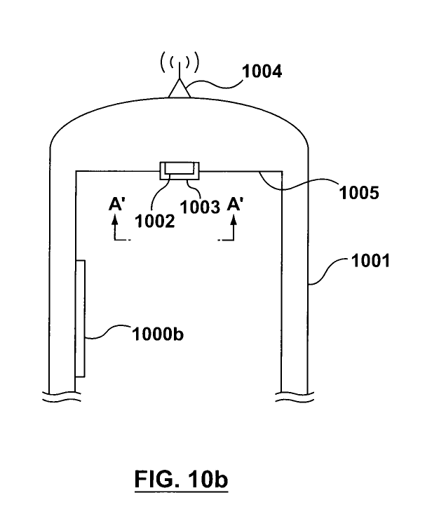

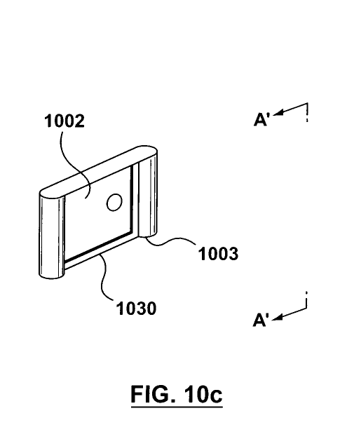

FIG. 10a is a block diagram showing portable structures 1001 that are arranged together in a bank. In FIG. 10b, a cross section of the interior for one of the structures 1001 is shown. Therein, interior audience sensor 1002 is mounted within an overhead mounting casing 1003. The data observed by sensor 1002 is provided to communication device 1004 for transmitting to data analyzer 1006 (shown in FIG. 10a). Sensor 1002 is similar to sensor 102 described above, and can be, for example, an IR counter or a camera that is used to track an audience 1011 that enters the portable structure(s) 1001 and is therefore exposed to advertisement 1000b provided therein.

In FIG. 10c a perspective view of casing 1003 and sensor 1002 taken along A′-A′ of FIG. 10b is shown. Casing 1003 may extend from a ceiling 1005 or other portion of structure 1001, or be flush mounted with ceiling 1005 or other portion as desired. In such embodiments, casing 1003 can be air and/or fluid-sealed so that, alone or in conjunction with ceiling 1005, casing 1003 protects sensor 1002 from moisture or other external agents. As shown, casing 1003 includes a cover 1030 to protect sensor 1002. Thus, casing 1003 forms environment resistant, and in some embodiments, a water, chemical, shock, and/or other resistant casing. Preferably, cover 1030 is a translucent or see-through panel for sensor 1002 to provide detection therethrough, but still provide water resistance and protection from the elements and other external agents. Having a water resistant casing to house sensor 1002 can tend to be advantageous in embodiments in which structure 1001 is used outdoors, such as for housing a portable toilet, which can be exposed to the elements, human excrements, and water and chemicals used in washing such structures.

Casing 1003 may be lockable, and in some embodiments it may have a bracketed component integrated into a component of portable structure 1002, such as, for example, the casing being molded into a roof or other panel of a structure, and having a translucent panel that may be lockably secured to the panel to provide an enclosed casing for sensor 1002.

Referring back to FIGS. 10a and 10b, when an audience 1011 enters a portable structure 1001, its associated sensor 1002 detects the audience 1011, and through communication device 1004 wirelessly transmits the gathered information, such as incrementing an audience count, to data analyzer 1006. Data collection and transmission can be in burst mode, at preset time intervals, or by other data carrier methods known in the art. Preferably, the transmission is real time so that data analyzer 206 is provided with current information.

Similarly, external sensor(s) 1012 can be provided with, on, in or near portable structures 1001 for detection members of audience 1010 coming into proximity of structures 1002 and are exposed to advertisements that are on or proximal to structures 1001, such as advertisements 1000. In the embodiment shown, sensors 1012 include IR-type sensors generating beams 1014 that, when broken by audience 1010 along path 1010a, indicates presence of member(s) of audience 1010 within effective proximity of advertisements 1000. In other embodiments, sensors 1012 can also make use of cameras to provide image(s) that are analyzed locally or remotely to obtain numbers and characteristics relating to audience 1010.

Data collected by sensors 1012 is provided to communication device 1016 for transmission to data analyzer 1006. As described above, it will be appreciated that other sensors or combinations of sensors may be desirable or can be used in other embodiments.

Data analyzer 1006 receives data collected by sensors 1002 and 1012 through wireless communication device 1008, similar to device 108 described above. In other embodiments, different communication formats, including wired communication, can be used.

It will also be appreciated that in various implementations, various schemes of wired and/or wireless communication can be achieved, in that the range of communication from data analyzer 1006 and device 1008 can be extended if remote communication devices 1004 and 1012 further provides repeater functions, so that a device 1004 or 1012 can communicate with device 1008 through one or more other device 1004 or 1012. This can also tend to lower power requirements at a single transmitter, if portable structures 1001 are arranged in proximity so that transmissions are relayed from a communication device 1004 of one structure 1001 to another device 1004 in another structure 1001. In addition to using a device 1004 associated with a sensor 1002 as a repeater, the use of a dedicated repeater can also aid with reducing transmission power and extending a network range.

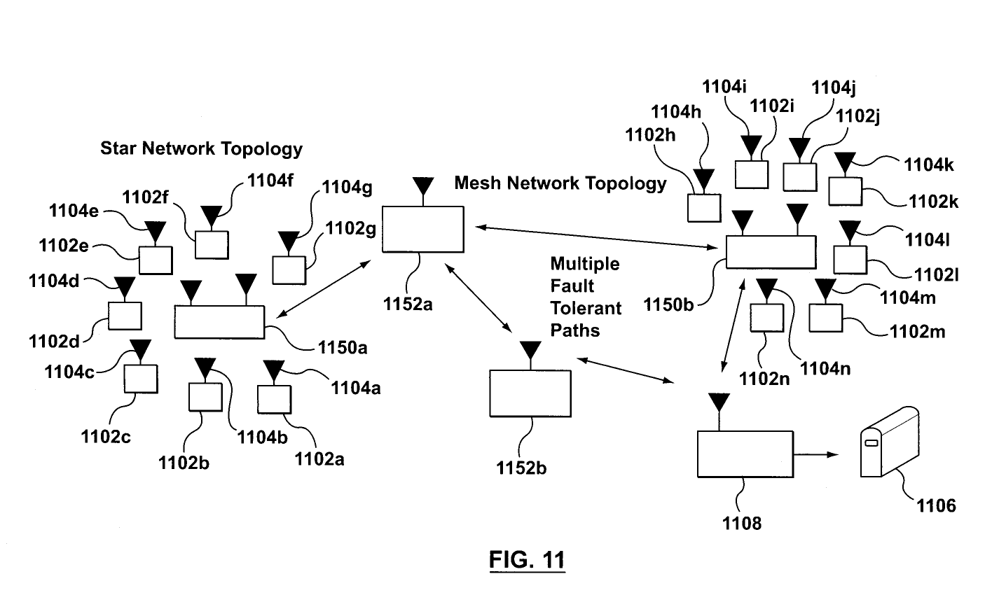

For example, in FIG. 11 there are shown multiple sensors 1102, each associated with one or more advertisements (not shown), and each of which is connected to a communication device 1104. In the embodiment, each of sensors 1102a-g and devices 1104a-g are in communication with repeater 1150a, and each of sensors 1102h-n and devices 1104h-n are in communication with repeater 1150b. Repeater 1150a and devices 1104a-g are connected in a star network topology. Repeaters 1150a and 1150b are also in communication with repeater 1152a, which in turn provides mesh network topology between devices connected along such repeaters. As shown, a processor, or data analyzer 1106 is connected to communication device 1108, which can connect to repeater 1150b (and the associated devices 1104) directly, or it can connect through other paths, such as through repeater 1152b and 1152a. As shown, device 1108 can also connect to devices 1104 associated with repeater 1150a through either repeater 1150b or 1152b. Providing multiple data paths tends to be advantageous in providing fault tolerance along transfer routes of data related to a particular advertisement to data analyzer 1106. Repeaters 1150 and 1152 that are suitable for use in the embodiment include the models of Point Repeater 4.9.9 and Point Repeater 9.9, available from Point Six Wireless. For the embodiment, sensors 1102, device 1104, device 1108, and data analyzer 1106 are similar to sensors 102, device 104, device 108 and processor/data analyzer 106 described above. It will be appreciated that in other embodiments, different network topologies can be use for communications between sensors and data analyzer at particular locations.

Depending on the selection of sensors, memory storage (if any) and transmission techniques utilized, either batteries and/or power line infrastructure can be used to provide electrical power to the various circuits and devices described above in FIGS. 1, 10 and 11.

Once audience tracking or characteristics data is gathered by a processor, or data analyzer (106, 1006 or 1106, above), this information can be mined, or otherwise statistically analyzed or used in marketing, demographic, audience control, and other processes. The information can also be used to generate performance measurements and action triggers. For example, the tracked data can provide statistical analysis opportunities, which may be used to gauge impressions and effectiveness of advertising structures and campaigns. Analytical tools may be provided with a data analyzer to review the effectiveness of displays, such as described below and in the incorporated references referred to above. The processor or data analyzer can be a computer system known in the art, with microprocessor, memory and data storage, network connectivity and computer programming implementing the above-noted features and functions.

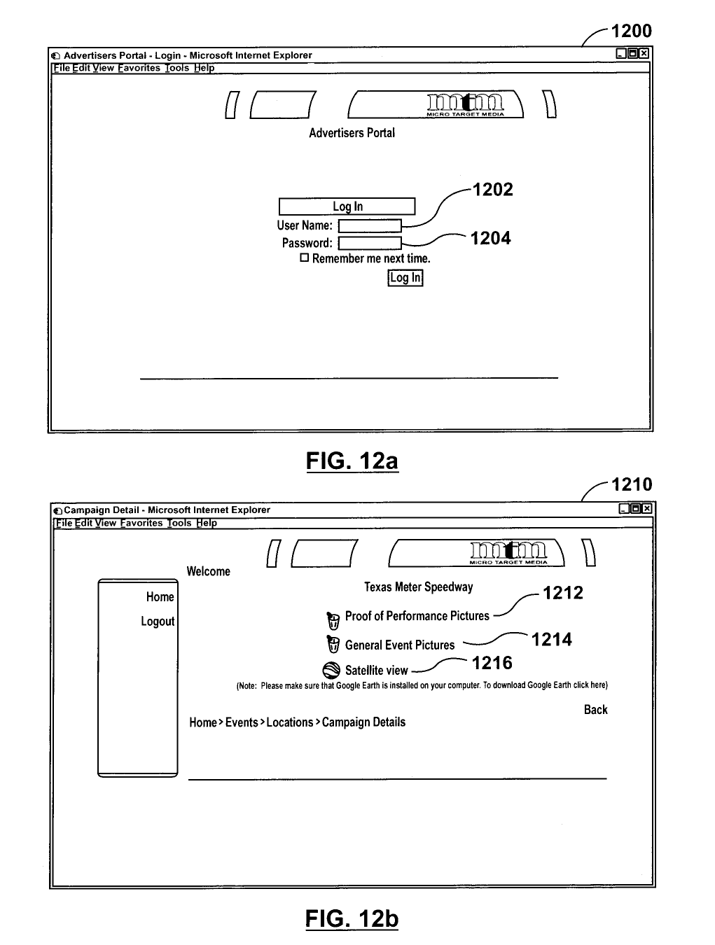

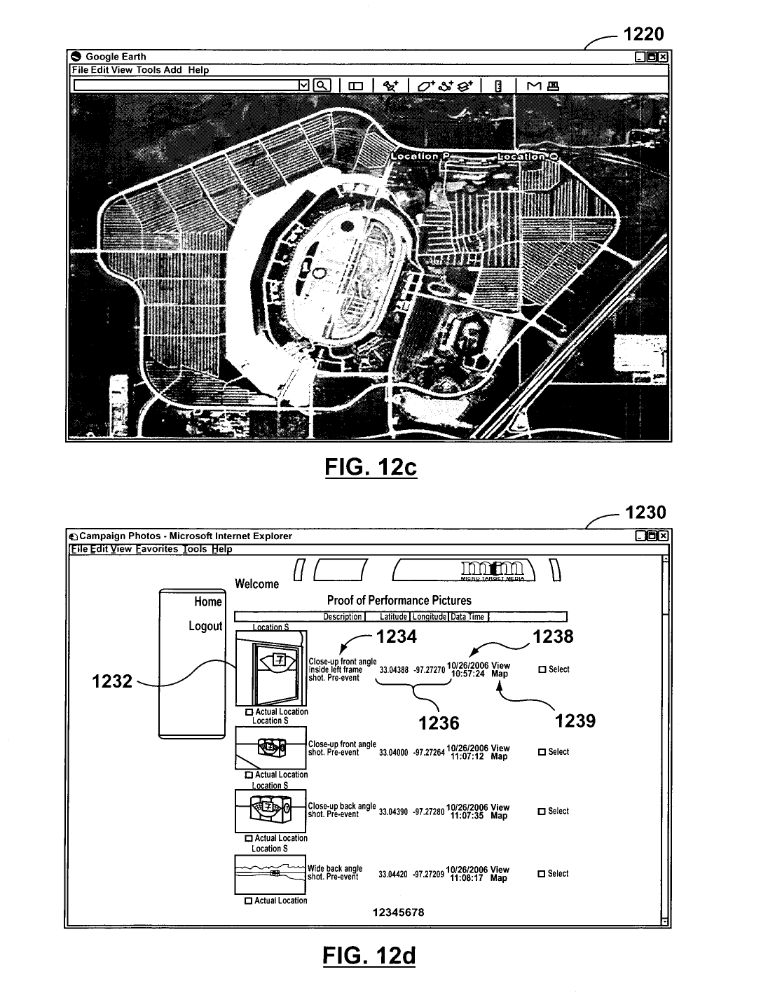

Referring to FIGS. 12a-d, there is shown a web-based portal interface useful for controlling data collection and other activities provided by processor(s) or data analyzer(s) 106, 1006, 1106. For example, in window 1200 user authentication/access functionality is provided through presentation of data entry areas or fields 1202 and 1204 useful for eliciting input of identifiers such as user login ID and password information, respectively. After authentication, window 1210 may presented, to show available information processing / data access features offered by data analyzer (106, 1006, 1106). Among other things, in the embodiment shown three selectable links are available, to display proof of performance pictures (1212), general event pictures (1214) and satellite view (1216). Upon selection of link 1216, a satellite view of one or more venues at which advertisements are deployed and tracked is displayed in window 1220. Using window 1220, a user can access real-time dynamic deployment reports of advertisements, such as for example advertisements deployed with portable structures 1001 as described above. From window 1210, if link 1212 is selected, then window 1230 will appear with images showing different deployed advertisements. For example, in window 1230 a picture 1232 is shown for a deployed advertisement, and a description 1234 associated therewith is also shown. Associated with the advertisement, its longitude and latitude information 1236 is also provided, along with a date/time stamp 1238 for the information. Additionally, links 1239 is provided for, among other things, options to view the advertisement's deployment on a map, such as a satellite map as shown in FIG. 12c.

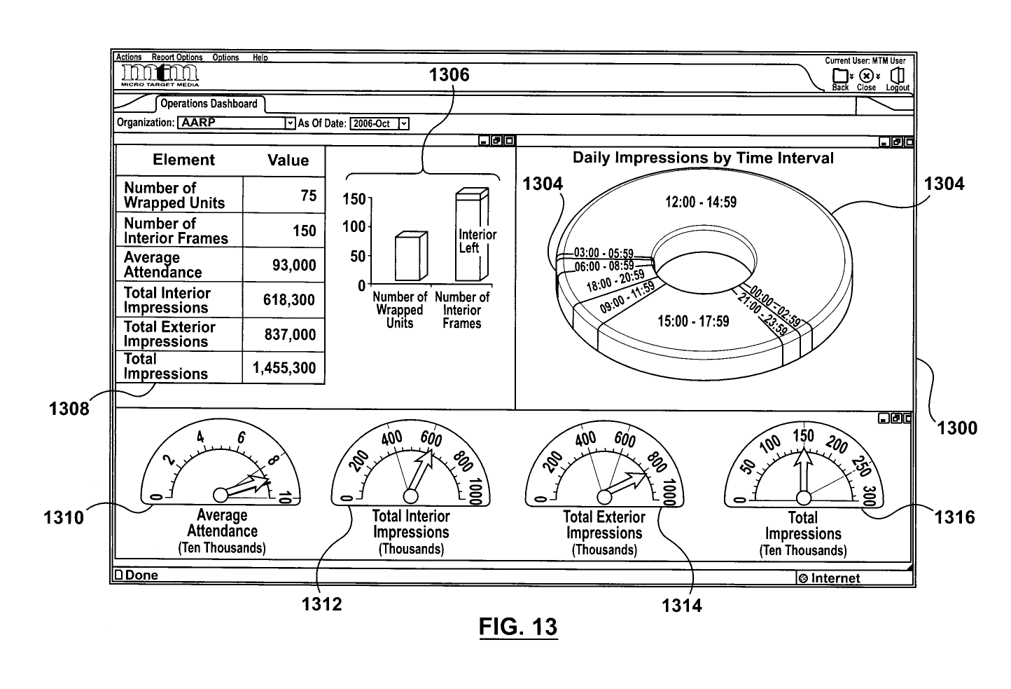

Data analyzer (106, 1006, 1106) can further provide additional sophisticated data analysis reports to a user, for example as in window 1300 shown in FIG. 13. For example, if an advertisement campaign is performed with portable structures, such as shown in FIGS. 10a-c, then there can be aggregate statistics collected and analyzed in real-time for the campaign. In window 1300, there are presented impressions (or total viewings by persons in an audience) by time interval pie graph 1302 that shows, per time interval or time slice 1304, the impressions over a time period, such as over a twenty-four hour day of an advertisement campaign. A total number of advertisements, or in this example, “wrapped units” or portable structures carrying advertisements and advertisements in the interiors of the structures, is shown in area 1306. Statistical breakdown in data collected is shown in area 1308, and average impressions by an audience over a time period, such as per day, are gauged and displayed in meters 1310, 1312, 1314 and 1316. This information can be securely accessed through the web portal shown in FIGS. 12a-d, and thus is available to a user over a TCP/IP or other internet connection remotely from the campaign site of portable structures and the associated data analyzer. It will be appreciated that other data can be tracked, analyzed and displayed to a user, as desired for a particular application.

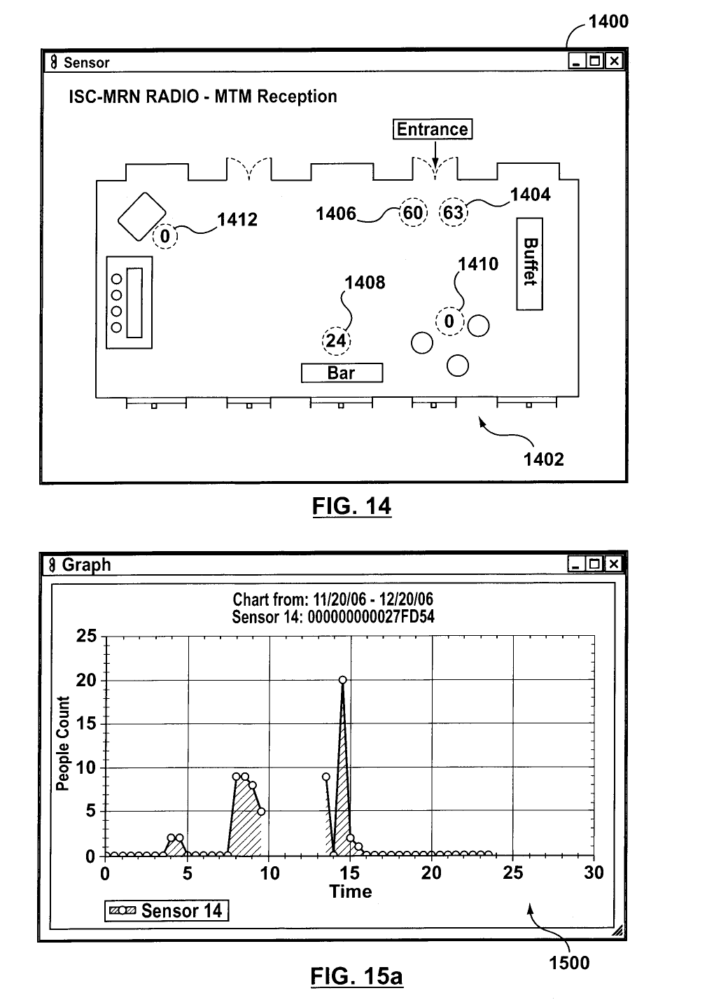

Referring to FIG. 14, window 1400 shows an overlay view by a data analyzer in another embodiment in which sensors are used to track both volume of audience in relation to individual advertisements and traffic patterns in a reception area or other interior/exterior building area 1402. Therein, two sensors are used to track audience members through a known high volume or restricted-traffic area, such as the entrance of a stadium, coliseum, theatre, or other entertainment venue, and provide an audience count at 1404 and 1406. Other sensors and tracked data include, at a seating area 1410, at the bar 1408, and at a television display 1412. In this embodiment, data relating to exposure to advertisements or other information materials placed in the reception area 1402, and the use of space by an audience, can be tracked and analyzed. Among other data collected, aggregates amount of and patterns used by traffic in the building area may be tracked.

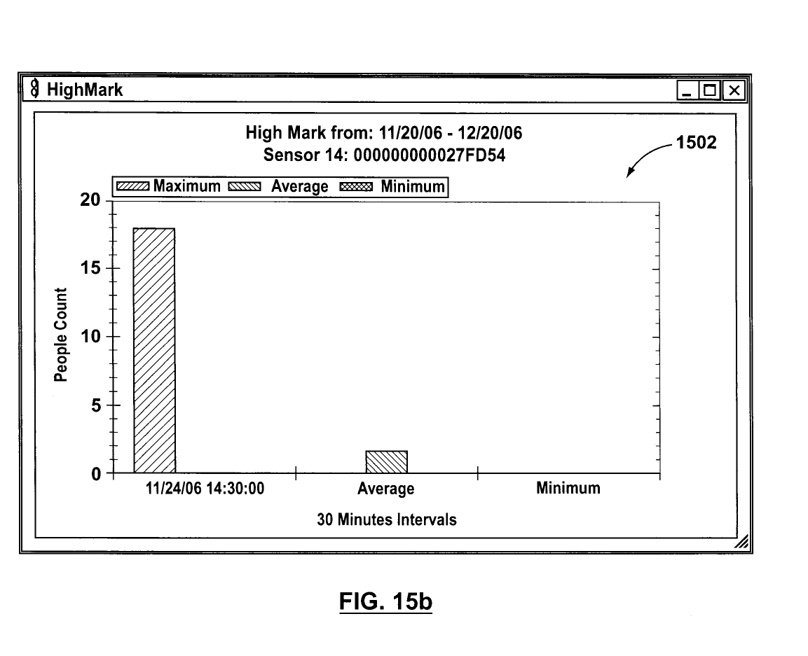

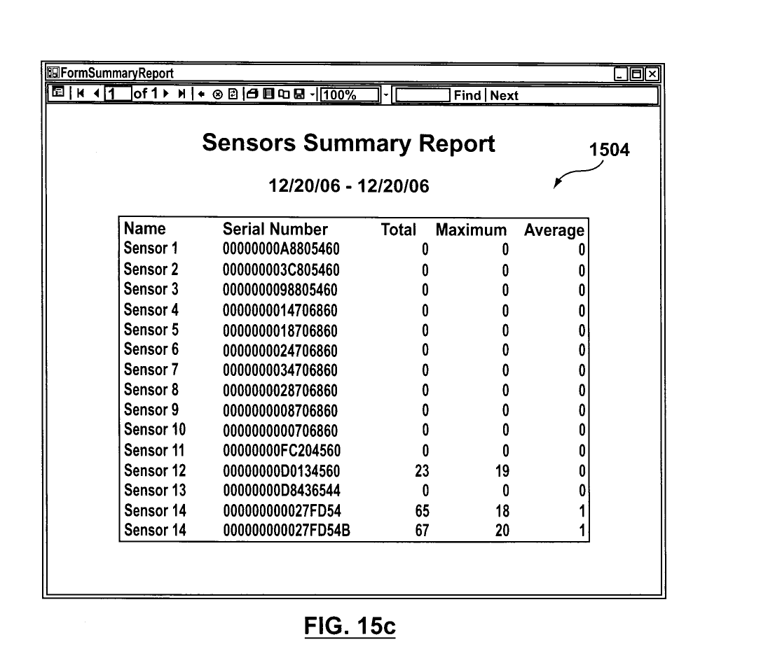

Referring to FIGS. 15a-c, examples of other informational displays and reports available from the processor, or data analyzer (106, 1006, 1106), are shown. In FIG. 15a, chart 1500 shows an audience count at particular times for a particular sensor in an implementation. In FIG. 15b, the maximum, average, and minimum audience detected by a sensor is shown in chart 1502. In FIG. 15c, a per sensor audience count summary is shown as report 1504.

Referring further to FIGS. 10a-c, in addition to statistical and advertisement performance analysis, the tracked data can be analyzed to provide regulation of deployment, performance, and workflow. For example, in an implementation of portable structures such as shown in FIGS. 10a-c in which the structures house portable toilets, the sensors 1002, 1012, along with tracked data by analyzed by data analyzer 1006, can provide real time feedback as to the volume of use of the structures 1001, so that cleaning, other maintenance, or other processes can be scheduled or triggered by data analyzer 1006 as a certain volume of use is anticipated or reached. Thus, alerts as to actions to be taken can be customized and automated by data analyzer 1006. For example, a message can be generated and sent remotely to a cleaning/maintenance crew to trigger the cleaning/maintenance activity as a volume of use is reached or being approached.

As mentioned, performance data regarding the volume of audience traffic (for example, audience 1010 and 1011) exposed to an advertisement 1000, 1000b can also be tracked. Information relating to volume of use and performance of a site can be utilized to adjust deployment of more portable structures 1001, such as increasing the number of structures 1001 and/or the number of advertisements with increasing volume of use and advertisement performance in particular locations. This can occur, for example, when sensors at particular locations detect that the estimated number of persons is above or below certain predetermined or dynamic thresholds volumes set within a data analyzer or data processor that is reflective of a particular advertising campaign at a venue.

The performance of a particular advertisement, or advertisements in a campaign at a venue, or over multiple venues, can be tracked, reported upon, and analyzed. For example, estimates of persons proximal to an advertisement on a portable structure can be tracked by a processor, or data analyzer. The estimates information can then be tabulated, reported and/or analyzed. In some embodiments, the performance can be analyzed as a function of the number of persons proximal to an advertisement to estimate advertising exposure. A report of advertising performance can also be generated by the system, which can be viewed on the Internet, as described above. Upon evaluation of the performance data, certain decisions can be made. These decisions can include increasing the number of advertisements at locations where the estimated number of persons are lower higher, or lowering the number of advertisements at locations where the estimated number of persons are relatively lower. For particular applications, performance characteristic thresholds can be set or dynamically calculated, so that real-time deployment, or re-deployment, of advertising and/or portable structures can be performed.

Data analyzer (106, 1006, 1106) can also overlay the tracked data with demographic information that is known from an event or site at which one or more advertisements are deployed. Referring again to FIGS. 10a-c as an example of a deployment of portable structures 1001, there is demographic information typically available with respect to particular sporting events at which such portable structures 1001 may be deployed. This demographic data can be analyzed alongside the tracked audience data in order to provide micro or macro data as to the performance of advertisements in particular demographics. Since the tracked data is provided over time, the reach of an advertisement 1000 or 1000b can be measured at a particular time during an event, or over a particular period of the event, as against certain demographics as that information is available.

It will be appreciated that computer programming can be used to implement aspects of the above-described features, using coding techniques known to one of skill in the relevant arts. Other combinations of hardware and/or software can be utilized in different embodiments.

As described above, in some embodiments, the sensors (102, 1002, 1102) and communication devices (104, 1004, 1104) described above can include RFID or other wireless technology to recognize and track suitably-compatible wireless or RFID devices carried or otherwise brought into and/or out of an area monitored for advertisement information. In such embodiments, demographic data can also be collected by the sensor(s) or communication device(s) associated with an advertisement, which can be analyzed along with other tracked data. Due to privacy regulations in certain jurisdictions, personal identifiable data can be filtered from collection in certain embodiments.

Referring to FIG. 1 again as an example, in some embodiments, advertisement 100 can be active in that it is analytical of audience 110. In an exemplary implementation, advertisement 100 can be displayed on a television. Sensor 102 or device 104, upon sensing demographic information (such as through RFID or by characteristics estimation as described above) of audience 110, causes a further targeted advertisement to be displayed on the television. This further display can be stored locally, or be obtained from data analyzer 106 upon communication of the demographic or other tracked information through data connection 112. Other multimedia or interactive features can be provided, such as the dispensing of coupons appropriate to data observed from audience 110 through sensor 102. If sensors 102 are enabled to observe viewer reaction, as described above, the advertisement that is shown can further also be adjusted in view of the reaction and other criteria that can assessed locally or at data analyzer 106. An interactive interface may also receive feedback from audience 110 regarding advertisement 100. In still other embodiments, other entertainment may be offered through passive displays or other interactive interfaces associated with advertisement 100.

In alternate embodiments, interactive interfaces with or in lieu of advertisement 100 to receive immediate feedback from users of the portable structure. In still other embodiments, entertainment may be offered through passive displays or other interactive interfaces.

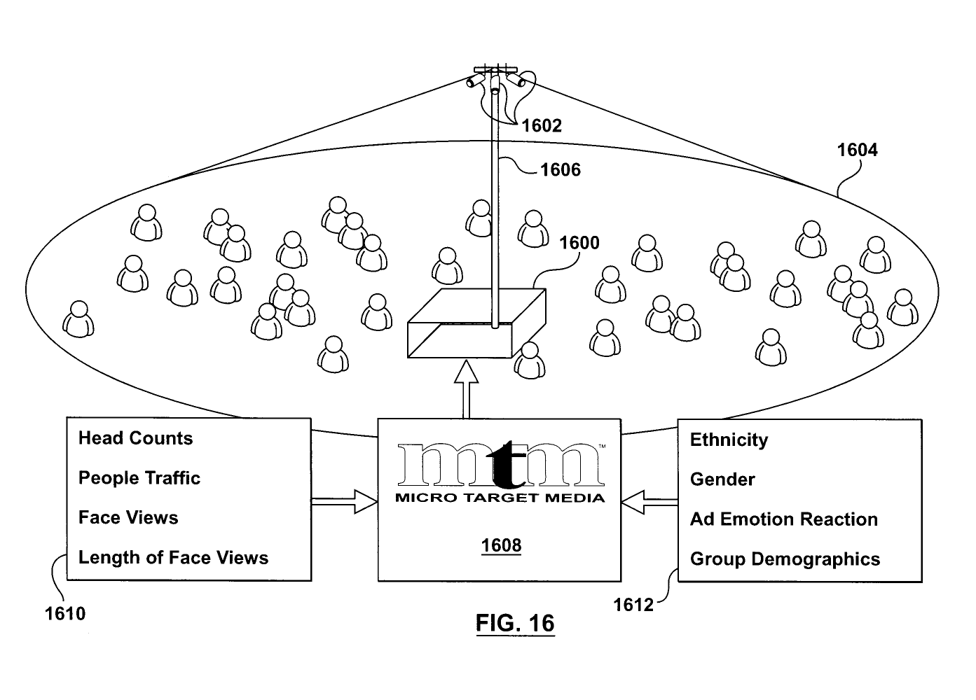

Referring to FIG. 16, there is shown another embodiment of the invention in which an exemplary visual (i.e., camera-based) estimation system is configured for use with mobile station 1600. It will be appreciated that other sensors, like sensor 102, can be used in other mobile embodiments.

In this example, station 1600 can include a vehicle, or a mobile platform that can be moved by a person or vehicle from location to location. The embodiment of FIG. 16 is useful, for example, for having an estimation system set up at temporary locations with one or more stations 1600 at a time and location when an event is taking place and estimations are desired.

As shown in FIG. 16, a plurality of cameras 1602 providing one or more visual representations can be connected to station 1600 via post 1606. For some embodiments, it can be desirable to elevate cameras 1602 above persons or objects to be counted, so that the dept perception of the visual representation(s) can be improved. It will be appreciated that in other embodiments, a mobile station can have multiple posts and/or other camera mounts to provide additional cameras 1602, visual sources, and/or viewing angles. Each station 1600, with its array of cameras 1602 can monitor an area 1604 defined by the viewing angle and range of its associated cameras 1602. In this example, mobile station 1600 is shown to be among persons in area 1604, and the numbers and/or characteristics of which, including demographics, can be estimated by the systems and methods of estimation as described above and operating in conjunction with mobile station 1600. Such estimation operation can occur locally at station 1600, or alternatively, raw, compressed, and/or processed data can be transferred live to another location for processing. Still alternatively, such data can be stored at station 1600 for a time, and then off-loaded or transferred for processing such as when mobile station 1600 returns to dock at a processing base or centre.

For the example shown in FIG. 16, processing as described above with reference to FIGS. 2 to 9 can be conducted locally at station 1600 with processing 1608. Processing 1608 include models for estimating, in the crowd in area 1604, different numbers and characteristics such as set out in data sets 1610 and 1612. These include head counts (or an estimate of the number of persons in area 1604), traffic density, face views, length of face views, ethnicity of viewers, gender of viewers, an emotional reaction (such as to an advertisement associated with station 1600) and/or group demographics.

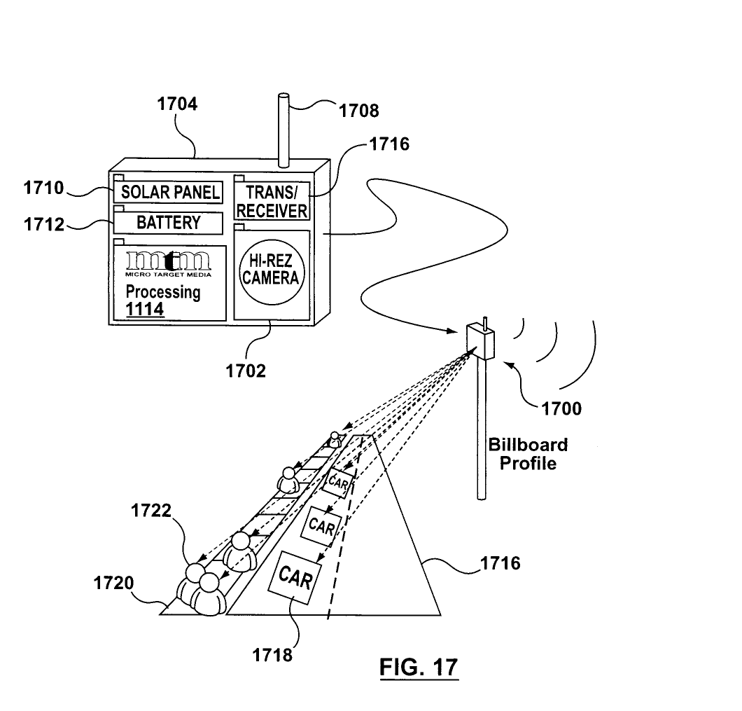

Systems and methods of estimation using a visual (i.e. camera based) system can also be used at a stationary position. Referring to FIG. 17, there is an exemplary embodiment in which the systems and methods of estimation are implemented at a fixed location, such as with a fixed billboard (shown in side view) advertisement. System 1700 can be set up with a billboard style advertisement that may have a passive or fixed image, or actively changing image or multimedia presentations. In system 1700, there can be provided an enclosure 1704 having one or more cameras 1702 that are set up to estimate the number and characteristics of possible observers to the billboard advertisement or objects near the billboard. System 1700 further includes a battery 1712 to operate the system's electronics and computing circuitry, and a solar panel 1710 to charge battery 1712 when there is daylight. Alternatively, wired AC power can be used as well. System 1700 further includes processing 1714 to process the visual representation(s) that are observed from camera(s) 1702, such as described above with reference to FIGS. 2 to 9.

System 1700 is also equipped with a trans/receiver 1706 connected to antenna 1708 for wirelessly transmitting the results of processing 1714 to a remote location for review. For example, the results of processing 1714 (such as number/probability curves, demographic information, face reactions and/or event statistics) can be transferred from system 1700 to a server (not shown) which then posts the results for access over the Internet or a private network. Alternatively, raw, compressed or processed data from camera(s) 1702 can be stored and later transferred, or transferred live, through wired or wireless connections to a remove location for estimation processing as described above with reference to FIGS. 2 to 9.

For the embodiment shown, system 1700 is set up near a road 1716 with sidewalk 1720. Camera 1702 are set up for observing vehicles 1718 on road 1716, and persons 1722 on sidewalk 1720 so as to be able estimate the number of persons and/or vehicles that come in proximity of an advertisement associated with system 1700, and to estimate characteristics such as demographics and/or reactions of viewers to the advertisement, such as face view estimations, gender/ethnicity estimation, face expression estimation, length of face views, persons/vehicle counts and traffic density, emotion reaction to advertisement, and/or demographics.

The observation of persons 1722 on sidewalk 1720 is similar to that described above, and so the details of which are now repeated here again. With respect to vehicles 1718, in addition to training to estimate the numbers and characteristics of the vehicles, system 1700 can also be trained to detect the direction of travel of vehicles 1718, so as to be able to determine the length of time that a billboard advertisement associated with system 1700 is, for example, in direct frontal view of a vehicle 1718 or the number of vehicles 1718 and the length of time that they are not in a direct frontal, but still visible angle to the billboard advertising. By utilizing higher resolution cameras 1712, it is also possible to observe and estimate the number and characteristics of persons in vehicles 1718 as well.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. A portable restroom system, comprising:
a portable structure having a toilet therein;
a sensor in the portable structure for detecting persons entering the portable structure; and
an advertisement inside the portable structure whereby the persons entering the portable structure is exposed to the advertisement,
wherein a count of the persons entering the portable structure is provided by the sensor.

2. The portable restroom system of claim 1, wherein the count of the persons is transmitted to a processor.

3. The portable restroom system of claim 2, wherein the processor is remote from the portable structure, the processor tabulating the count of persons over different time periods for the portable structure.

4. The portable restroom system of claim 3, wherein the processor generates a message upon detecting the count of the persons has reached a threshold, the message being sent to a receiving device to initiate an activity for the system.

5. The portable restroom system of claim 4, wherein the activity is cleaning of the portable structure.

6. The portable restroom system of claim 5, wherein the processor receives another count information relating to another number of persons entering another portable structure, the another portable structure having another advertising associated with the another portable structure, the another portable structure having another sensor associated with the another portable structure, and the processor tabulates the count of persons and the another count information to provide a report.

7. The portable restroom system of claim 6, wherein the report includes a total count of persons exposed to the advertising in the portable restroom system.

8. The portable restroom system of claim 4, wherein the activity is deploying another portable structure proximal to the portable structure.

9. A system for tracking a performance of an advertisement, comprising:
a sensor for counting a number of persons proximal to the advertisement; and
a processor receiving from the sensor the number of persons, the processor tabulating the performance of the advertisement as a function of the number of persons over one or more time periods,
wherein the tabulating the performance provides a report on the advertisement, the report being used analyzed for a decision regarding the advertisement.

10. The system of claim 9, wherein the sensor and the advertisement are attached to a portable structure.

11. The system of claim 10, wherein the advertisement is inside the portable structure, and the sensor is adapted to estimate the number of persons proximal to the advertisement inside the portable structure.

12. The system of claim 11, wherein the portable structure is a portable restroom.

13. The system of claim 12, wherein the sensor is an infrared sensor.

14. The system of claim 10, wherein the advertisement is attached to an exterior of the portable structure.

15. The system of claim 14, wherein the portable structure is a portable restroom.

16. The system of claim 15, wherein the decision includes updating the advertisement, upon the report indicating that the performance of the advertisement is above a threshold.

17. The system of claim 16, wherein the decision includes deploying another portable structure with the advertisement attached thereon proximal to the portable structure.

18. The system of claim 15, wherein the decision is to replace the advertisement, upon the report indicating that the performance of the advertisement is below a threshold.

19. The system of claim 15, wherein the sensor is a thermal sensor.

20. A method for tracking a performance of an advertising campaign, comprising:
estimating a number of persons proximal to each of one or more advertisements placed throughout a venue;
receiving the estimated number for each of the advertisements;
determining the performance of the advertising campaign as a function of the number of persons over one or more time periods for each of the one or more advertisements; and
evaluating the performance of the advertising campaign, and making a decision regarding the advertising campaign as a function of the performance of the advertising campaign.

21. The method of claim 20, wherein at least one of the one or more advertisements are attached to a portable structure.

22. The method of claim 21, wherein the at least one of the one or more advertisements is inside the portable structure, and the estimating of the number of persons proximal to the at least one of the one or more advertisements is performed by a sensor adapted to estimate the number of persons proximal to the at least one of the one or more advertisements inside the portable structure.

23. The method of claim 22, wherein the portable structure is a portable restroom.

24. The method of claim 23, wherein the sensor is an infrared sensor.

25. The method of claim 21, wherein the at least one of the one or more advertisements is attached to an exterior of the portable structure.

26. The method of claim 25, wherein the portable structure is a portable restroom.

27. The method of claim 26, wherein the decision includes updating the advertisement if the performance of the advertising campaign is above a threshold.

28. The method of claim 26, wherein the evaluating the performance of the advertising campaign includes determining a location at the venue at which the number of persons proximal to one of the one or more advertisements is relatively higher, and the decision regarding the advertising campaign includes deploying at least one of an additional advertisement or an additional portable structure at the location.

29. The method of claim 26, wherein the evaluating the performance of the advertising campaign includes determining a location at the venue at which the number of persons proximal to one of the one or more advertisements is relatively lower, and the decision regarding the advertising campaign includes removing at least one of the one or more advertisements from the location.
